(19) United States
(12) Patent Application Publication
(10) Pub. No.: US 2004/0015451 A1
(43) Pub. Date: Jan. 22, 2004

(54) Method for conducting financial transactions utilizing infrared data communications

(76) Inventors: Jagdeep Singh Sahota, Rodeo, CA (US); Thanigaivel Ashwin Raj, Newark, CA (US); Ann-Pin Chen, Foster City, CA (US)

Correspondence Address: Pepper Hamilton LLP, 50th Floor, One Mellon Center, 500 Grant Street, Pittsburgh, PA, 15219, US

(21) Appl. No.: 10/439,625

(22) Filed: May 16, 2003

Related U.S. Application Data
(60) Provisional application No. 60/394,881, filed on Jul. 10, 2002.

(51) Int. Cl. G06F 17/60

(52) U.S. Cl. 705/71

(57) ABSTRACT

A method and device are described for conducting a transaction between electronic devices in which transaction data is exchanged over an infrared frequency. A first and second electronic device, with a common encryption algorithm deployed on each device, establish an infrared communications link. The second electronic device transmits a transaction request together with an encryption key to the first electronic device. The first electronic device returns response data to the second electronic device which response data is encrypted using the common encryption algorithm and the encryption key. An account to be utilized in the transaction is derived from the response data allowing the transaction to be completed.

### CROSS REFERENCES

This application claims priority to U.S. Provisional Application Serial No. 60/394,881, filed Jul. 10, 2002, the contents of which are incorporated herein by reference in its entirety.

### BACKGROUND OF THE INVENTION

Consumers today have a myriad of financial instruments available to them for conducting a consumer transaction at a point of sale. For example, with almost each transaction, consumers are asked to choose between any number of different payment options, including credit cards, debit cards, cash and checks. In addition, consumers will commonly carry multiples of these instruments which have been issued by different or even the same financial institution, such as multiple credit cards issued by different banking institutions. Furthermore, consumers may also carry instruments ancillary to consummating the transaction, such as loyalty cards or coupons which may be used in the course of a transaction. Each of these instruments has a separate physical embodiment which must be carried with the consumer to be available for use. Commonly, these physical instruments will be carried in a wallet, pocketbook attached to keychains, or otherwise to facilitate use.

Of these, one of the most commonly used for conducting a consumer transaction are magnetic stripe cards which includes credit cards, debit cards, check cards and other instruments. Indeed, credit cards and credit card transactions are ubiquitous, with billions of dollars each year being charged to hundreds of millions of issued credit cards. Magnetic stripe credit cards provide consumers with an easy and secure method for paying for a transaction which is also widely accepted around the world. As used herein, credit card shall mean any magnetic stripe card, including cards for conducting a credit transaction, a debit transaction, check cards and loyalty cards.

In a typical credit card transaction, a consumer will approach the point of sale to purchase one or more items. The point of sale may be automated, or attended by a representative of the merchant. The items to be purchased may be identified to a point of sale device, such as a cash register, and the total bill of sale will be determined. At that time, the consumer will be requested to identify their means of payment. If the consumer elects to pay for the items using a credit card, the consumer will present the card at the point of sale, which will swipe the card through a magnetic card reader, such as that disclosed by Chang, et al. in U.S. Pat. No. 4,788,420. The magnetic reader will access account information stored on a magnetic stripe on the back of the credit card and will use such information to determine the approval or disapproval of the transaction. In some instances, the consumer may be required to enter a personal identification number (i.e. PIN) and/or to sign a paper receipt indicating approval of the transaction. Optionally, the signature may be made on a scanning device incorporated to the magnetic stripe reader, such as that disclosed by Terrell in U.S. Pat. No. 6,076,731.

As the number of financial instruments have multiplied, attempts have been made to consolidate the functionality of such various instruments. For example, integrated circuits were imbedded on credit cards to provide substantially increased functionality. Credit cards with imbedded integrated circuits (known commonly as integrated circuit cards) represented a significant increase in functionality over magnetic stripe cards. The integrated circuit typically included memory such as random access memory (RAM) and electrically erasable programmable read only memory (EEPROM) which allow the integrated circuit card to store orders of magnitude more information than the typical magnetic stripe card. In addition, the integrated circuit will typically include a microprocessor for managing data flow and processing instruction sets. This allowed issuers of integrated circuit cards to include multiple financial instruments on a single card. For example, a single integrated circuit card may provide the functionality for conducting credit based transactions, debit transactions, ATM functionality, as well as reward programs, discounts and special offers.

Ultimately, credit cards began to find use in non-traditional environments such as taxi cabs, transit locations, gas station pumps and vending machines. Contactless credit cards were developed to facilitate the expanded use of credit cards in commercial transactions. Basically, a contactless credit card utilized radio frequency technology to communicate with the card reader. The contactless credit card has coiled antennae within the card itself which provides communication between the card and the reader and also provides means for powering the card by an inductively coupling the card to an electromagnetic field.

In addition to expanding the use of credit cards, contactless technology seeks to significantly reduce one of the primary cost components for credit cards. Both magnetic stripe cards and integrated circuit cards must be placed in physical contact with a reader, which transfers the data residing on the card (either the magnetic stripe or the memory in the integrated circuit) to the point of sale for processing. In both cases, the physical contact required for such reading step results in wear and tear on the card itself, ultimately requiring its replacement at additional cost. Attempts at utilizing RF technology eliminated the need to place the credit card in physical contact with a reader thereby significantly reducing this physical cost component. Nonetheless, even contactless credit cards will require replacement due to expiration, theft, and loss, with the associated replacement costs.

Most recently, use of infrared technology has been explored as means for communicating the necessary information to conduct a consumer transaction. Communications utilizing infrared technology have been known and utilized for many years. Infrared data exchange technology is estimated to be in over 300 million electronic devices, including desktop computers, notebook computers, palm PC's, printers, digital cameras, public phones/kiosks, cellular phones, pagers, personal digital assistants, watches, and other mobile devices. Infrared technology provides a high speed, short range, line of sight, wireless data transfer technology which is suitable for one-way or bi-directional data exchange. For example, infrared technology is widely used to exchange information between physical components of a computer such as printers, mice and keyboards, and also providing an interface to digital cameras and PDA's.

To provide a standardized system for utilizing infrared data exchange technology in consumer transactions, the Infrared Data Association (IrDA) has, in collaboration with its members, developed the Infrared Financial Messaging (IrFM) Point and Pay Profile. This profile provides for a standard means for conducting a financial transaction between two infrared-enabled devices. For example, a PDA or mobile phone would be preloaded with a consumer's financial instruments and have the ability to initiate a credit card, debit card, or check transaction via infrared transport of the necessary information to the point of sale. The information that is stored in the consumer's device would be transmitted to a credit card reader, ATM or other point of sale terminal for payment processing.

Implementation of the IrFM Point and Pay Profile requires use of a networking protocol stack based largely on the OSI 7-Layer Model. FIG. 1 shows the protocol stack as implemented on both the PTD, and the POS. FIG. 1a shows a representation of the stack implemented on the PTD. At the physical layer is the IrDA hardware 101 which is needed to support the functionality for infrared data exchange. Proprietary protocols have been developed for both the data link layer 102 and the network layer 103 for establishing the orderly transfer of data between the devices. The transport layer 104 uses a Tiny TP protocol for managing the exchange of data packets. OBEX session protocols 105 reside at the session layer. The POS and PTD will operate in a client-server relationship. The PTD will respond to requests for interaction made by the POS and therefore will serve in the role of server and the POS will function as the client. The IrDA has developed core protocols 106 which sit on the OBEX server and support the proprietary financial instruments 107. Similarly the POS has a corresponding stack, shown in FIG. 1b with the necessary hardware 110, data links 111, network protocols 112, any data exchange protocols 113. The POS operates in the role as an OBEX client 114 at the session level and will support any corresponding core protocols 115. The POS will have proprietary services 116, installed which must correspond with proprietary services on the PTD 107 in order for a transaction to be conducted.

Utilizing the stack described in FIG. 1, PTD's can continuously operate in a normal environment from 1 to 2 meters away. If power consumption by the PTD is of particular concern, or if battery levels are low, a low power mode can be utilized allowing effective operation from 20 to 30 centimeters away. In the low power mode, the power consumption may be as much as 10 times less than the power required for normal operation.

Although the IrDA profile describes the protocols for the exchange of data to conduct a financial transaction over an IR-enabled network, the profile does not describe the methodology of implementing a financial instrument, such as a credit card. Accordingly, there is a need for a methodology for implementing financial instruments operating in an IR-enabled environment. In addition, there is a need for an application utilizing a quick and secure IR data exchange to effect a point of sale transaction at a fixed price.

### SUMMARY OF THE INVENTION

The present invention describes a method for conducting a credit or a debit transaction utilizing IR-enabled mobile electronic devices in communication with IR-enabled point of sale devices. The present invention enables a mobile electronic device to effect a transaction with a point of sale device where the transaction is accomplished with minimal data exchanged between the IR-enabled mobile electronic device and the IR-enabled POS device. In an alternate embodiment, the IR-enabled mobile electronic device is pre-loaded with the information necessary to conduct a standard magnetic stripe based credit or debit transaction. When conducting the transaction, standard protocols for conducting a financial transaction may be utilized.

### BRIEF DESCRIPTION OF THE DRAWINGS

FIGS. 1a and 1b are representations of the IrDA protocol stack implemented on a mobile electronic device and point of sale terminal.

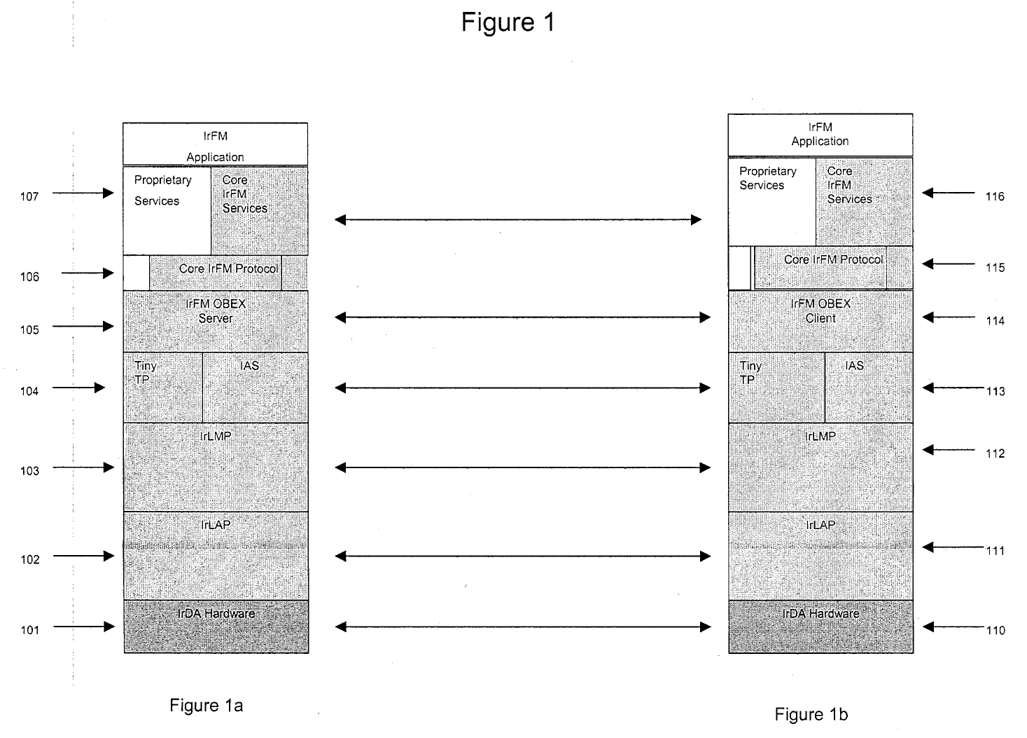

FIGS. 2a and 2b is a drawing of the modified IrDA stack on a mobile electronic device and a point of sale device which is part of the present invention.

FIG. 3 is a flow diagram of the steps to complete a transaction with minimal data exchanges in the present invention.

FIG. 4 is a record diagram of the data primitive utilized in the present invention.

FIG. 5 is a flow diagram of the steps to complete a transaction in the present invention.

FIG. 6 is a flow diagram of the steps to complete a transaction and provide a transaction receipt in the present invention.

### DETAILED DESCRIPTION OF THE INVENTION

The present invention provides a method for conducting a transaction utilizing an IR-enabled portable electronic device which has some or all of a customer's payment applications deployed thereon. The present invention allows consumers to utilize their personal digital assistants (“PDA's”), pagers, mobile phones, and other electronic personal trusted devices (collectively referred to as PTD's) to store financial instruments thereon for use in conducting a transaction with an IR-enabled point of sale terminal (“POS”) where data exchange is by infrared communication. A single hand held device can be utilized to preferably store and manage all of a consumer's financial instruments, including credit cards, debit cards, checks, cash, loyalty cards, gift cards, and other similar instruments. In such a manner, the consumer can eliminate the need to separately carry physical instruments for each of the transactions, while retaining the functional ability to pay through various means.

In addition, the present invention may be utilized to exchange financial information and assets outside a retail setting such as in business to business exchange or in personal peer to peer exchanges. For example, in a business to business setting, the present invention allows companies entering into contractual relationships to make required payments under the contract simply by connecting PTD's and exchanging the appropriate financial data. In addition, in a non-commercial setting, the present invention may be used to exchange financial assets between accounts. For example, a parent may debit their child's account as the child matriculates to school rather than writing a paper check or providing cash. The child could then use the PTD to purchase necessary supplies.

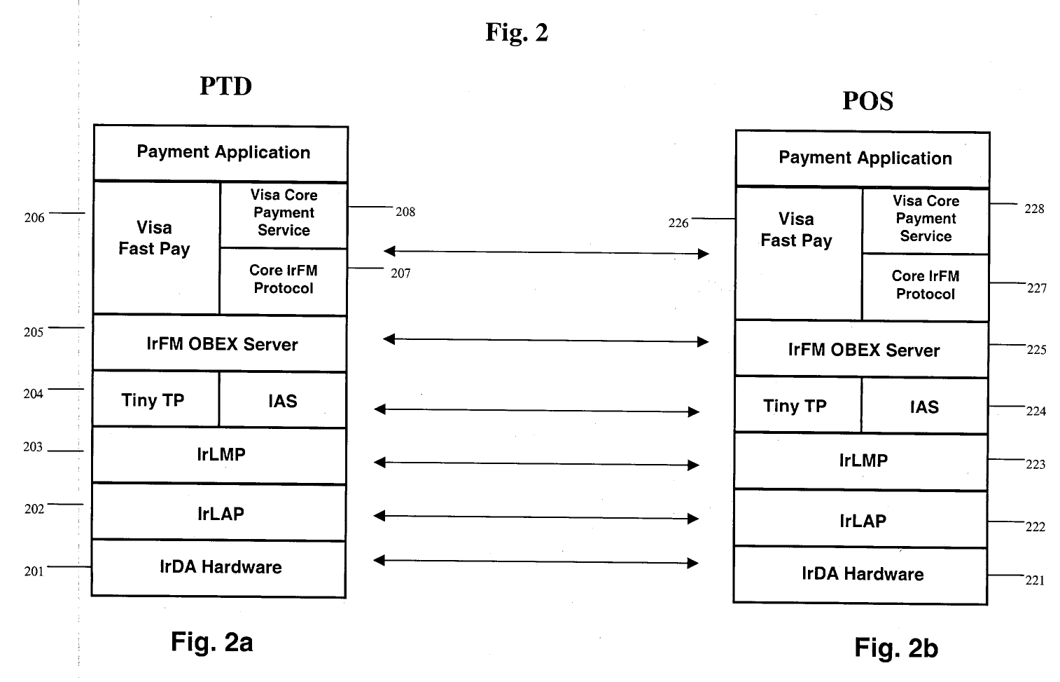

The present invention provides a quick and secure method to utilize a PTD to conduct fixed price transactions. As shown in FIG. 2, a modified IrFM stack is deployed on a PTD and a POS. As shown in FIG. 2a, the PTD has an IrDA hardware layer 202, IrFM specified protocols at the data link layer 202, a network layer 203, and the transport layer 204. As with the IrFM compliant stack, the session layer 205 may similarly be configured with OBEX session protocols. However, in contrast to the IrFM stack, the present invention deploys the payment service application 206 directly on the session layer 205. In order that the PTD may function with other applications, such as IrFM-compliant applications, the core protocols 207 utilized in a standard IrFM environment also sit directly on the session layer 205. This allows use of the PTD with services 208 which rely on the core protocols 207 which services 208 sit on top of the core protocols 207 themselves.

FIG. 2b shows the required stack mirrored on the POS with the corresponding hardware layer 221, data link layer 222, network layer 223, transport layer 224, and session layer 225. As with the PTD, on the POS the present invention deploys the payment service application 226 directly on the session layer 225. Similarly, the core protocols 227 necessary to support additional IrFM-compliant services 228 also sit directly on the session layer 225. Utilizing the stack configuration shown in FIG. 2, an application for performing a transaction, or other exchange of data, can be accomplished quickly and securely. As a result, the present invention finds use in environments not typically amenable to non-cash based transactions such as transit environments, street vendors and vending machines.

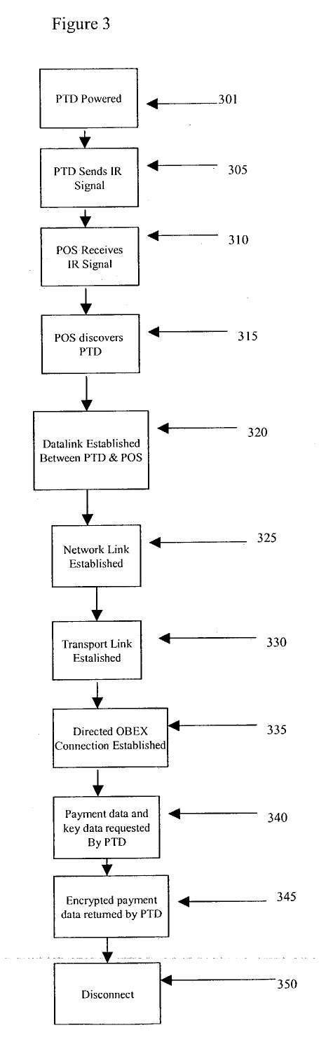

As shown in FIG. 3, the PTD is powered 301 and sends a IR signal 305 indicating it is ready to initiate data exchange. The POS receives the IR signal 310 from the PTD and discovers the PTD 315. A data link is established 320 between the PTD and the POS as is a network link 325 and a transport link 330.

Next, the PTD establishes a directed OBEX connection 335 with the POS. A directed OBEX connection is a targeted connection between intended services or applications. A directed OBEX session 335 is established between the payment service which resides on the PTD and the corresponding payment service which resides on the POS device. Once the OBEX session is established, the POS and the PTD operate in a client-server relationship where the POS serves as the client and the PTD the server. Although, optionally, the PTD and POS may establish a reliable OBEX session, the present invention makes this extra step unnecessary. A reliable OBEX session allows the PTD and POS to re-establish a prematurely terminated connection at the same data transmission point at which the connection was terminated. As a result, when a reliable OBEX session has been established, a transaction will not have to be restarted anew in the event of a prematurely terminated connection; rather it will be possible to pick up the transaction at the point the transaction was lost. However, this optional step is not necessary. The number of data exchange steps has been minimized in the present invention, therefore the likelihood of a premature termination has been significantly reduced.

Once the directed OBEX session 335 has been established, the PTD requests payment data and key data 340 from the POS. Once this data is received, the PTD returns to the POS payment response data in a data primitive 345 which is described more fully in FIG. 3. The payment response data is encrypted utilizing the key data received from the POS and a common encryption algorithm which has been preloaded on both the POS and PTD. Once the POS receives the payment response data from the PTD, the connection is terminated 350 and the POS completes the transaction without further communication with the PTD.

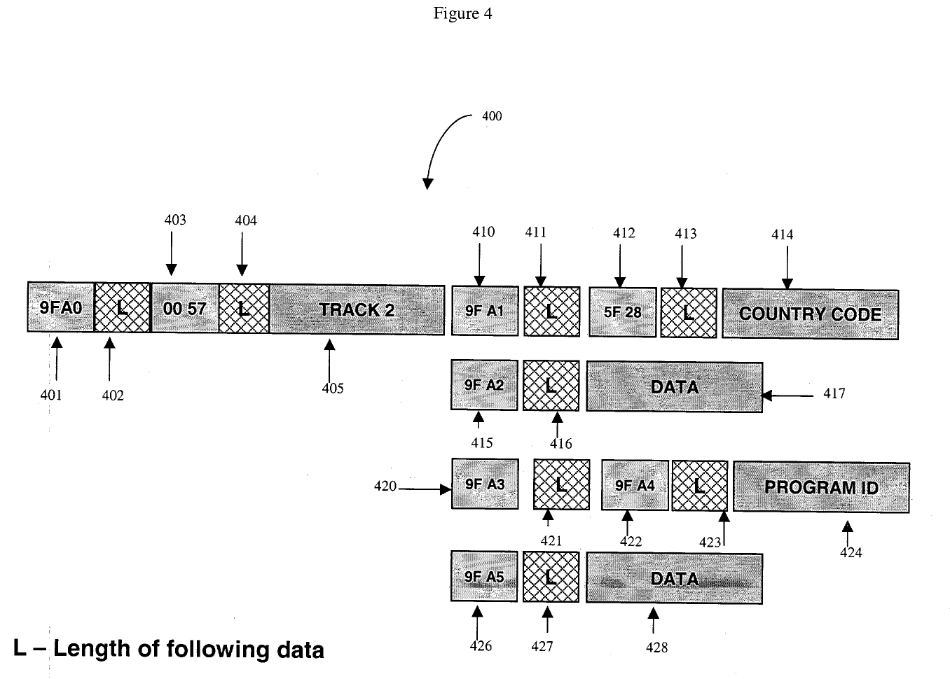

FIG. 4 is a diagram of the payment primitive which is utilized in communications between the PTD and the POS in the present invention. As used in this context, a primitive is a set of data objects which can be used to exchange information in the course of the transaction. As shown in FIG. 4, the payment primitive 400 has three data tags, which identifies three data sets to be exchanged. The first data tag 401 identifies the entire primitive 400 and is mandatory. This tag 401 is followed by a length identifier field 402 which identifies the total number of bytes in primitive 400. Field 403 is an indicator field which indicates that account information is following and will be of a length set forth in the length identifier field 404. The data object for the account information 405 follows. The account information may include an account number necessary to identify the service being provided by the issuer of the service. For example, the service may be a stored value card issued by a merchant and the account information may comprise information necessary to update the stored value account. In an alternate embodiment, the account information comprises track 2 data for a credit card. Track 2 data is understood in the credit card industry to refer to that data which is necessary to a credit card transaction and includes the account number for the service being provided, expiration date, the name of the card service holder, and necessary service codes.

Optionally, the primitive 400 may have two additional data sets, each identified by separate tags. The optional second tag 410 identifies the data set for the exchange of domestic data. Domestic processing data refers to data such as an ISO-compliant country code, data allowing for the accommodation of domestic variations in payment information and transaction processing requirements, an identifier for the provider of the service identified in the account information 405, and data to enable a transaction to be processed internally within its country of origin. For example, market research such as country specific tracking and usage analysis, could also utilize this optional data field. Using these fields, purchasing trends can be tracked including the number of items purchased, locations of purchases, time of purchases, and other information useful or desirable in monitoring trends. The domestic data set can be of variable length not exceeding 256-bytes which is identified in the length identifier field 411. The country code data is identified by a country code tag 412 with a length identifier field 413 which is restricted to a 2-byte length. Other lengths are not necessary as the country code which is set forth in field 414 is ISO-compliant. The domestic processing data set is identified by tag 415, can be of variable length set forth in the length identifier field 416, with the data residing at field 417.

The optional third tag 420 identifies the data set for issuer program data which includes data related to voucher-type services, such as loyalty programs, coupons, tickets, issuer identification details and similar services. When used in conjunction with coupons, tickets, and some loyalty programs, the issuer program data comprises key data which is used to access and enable such coupons, tickets, or programs at remote locations. In addition to providing for the implementation of loyalty initiatives at merchant locations, the issuer can provide for the charging of a fee for specific programs through use of this data set. Further, issuer program data may include an identifier in instances where the service provided is co-branded. For example, the user may accumulate frequent flyer miles by using the service when the service is co-branded with a participating airline. The issuer program data fields can be used to identify the participating airline and/or the frequent flyer account of the user. The issuer program data set can be of variable length not exceeding 256-bytes which is identified in the length identifier field 421. The data set for the program identification, which provides for identification of the particular voucher or other service which an issuer may implement through use of this data set, is identified by tag 422 with a length identifier field 423 which is restricted to 4-bytes. The program identification field 424 contains a unique identifier for the program, which identifier typically will be the last four bytes of the universally unique identifier (“UUID”) for the program. Alternately, the program identification field 424 may utilize unique identifiers other than the last four bytes of the UUID. For example, the unique identifier may be any four bytes of the UUID, unrelated to the UUID, a hash of the UUID, or an identifier unrelated to the UUID. As used herein, the UUID is a 128-bit value which is guaranteed to be unique across space and time until roughly 3400 A.D. Additional data required for the implementation of the program is identified by tag 426, can be of variable length set forth in length identifier field 427, with the data residing in field 428.

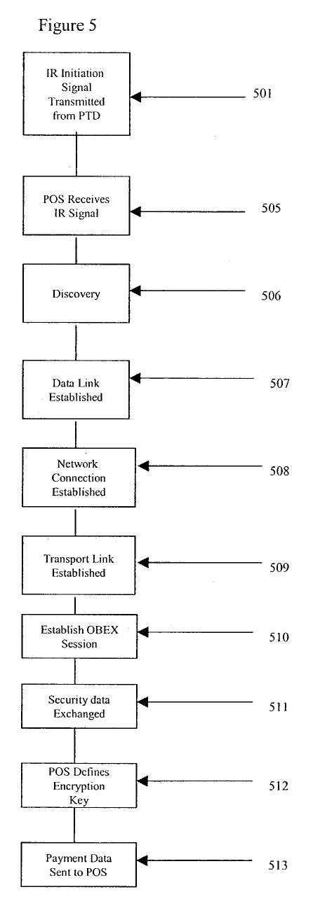

An alternate embodiment of the present invention allows a consumer to conduct a financial transaction largely as such a transaction is conducted in a card-based environment. Typically, the consumer would approach the point of sale and identify the one or more items to be purchased. When the total bill of sale is determined, rather than reaching for their wallet to choose from a multitude of financial instruments the consumer powers on the hand held device to pay for the transaction. FIG. 5 is a flow diagram of the steps followed to accomplish a transaction in this embodiment of the present invention. The PTD generates an IR signal 501 which is received by the POS 505. The POS determines that the PTD is attempting to initiate a transaction and begins the discovery process. The discovery 506 of the PTD by the POS is accomplished and a data link 507, network connection 508 and transport link 509 are established. Next, the POS initiates a reliable directed OBEX session which is established with the PTD 510. Although the IrDA compliant stack specifies use of an OBEX session, other session protocols may be used. When a reliable OBEX session is used the PTD and the POS can re-establish a terminated connection at the same data transmission point at which the connection was lost. As a result, the transaction will not have to be restarted anew, rather it will be possible to pick up the transaction at the point the transaction was lost.

Once the session is established between the POS and the PTD, the POS will communicate to the PTD a list of financial instruments which the POS supports. For example, the POS may support credit and debit card transactions, and may also include other instruments. The PTD checks the list received from the POS and commonly supported applications are displayed to the user for selection. A connection is then established between a common payment service on both the POS and the PTD. The POS device and PTD exchange information regarding the type of security to be used for the transaction 511. Various levels of security can be used for a given transaction, the only requirement being that the type of security must be supported by both the PTD and the POS. Next, the POS provides the PTD a definition of the encryption key to be used in the exchange of information 512. This may contain information such as the data required to generate a key, certificates in an asymmetric implementation, or the key data itself in a symmetric key environment. Next, a payment primitive is communicated from the PTD to the POS 513. The payment primitive, such as that shown in FIG. 4, provides for the exchange of information necessary to affect payment of the transaction, as well as information related to vouchers, loyalty programs, gift cards, and other instruments that may be pre-selected. The payment information is presented to the point of sale device, which proceeds to process the transaction in its normal manner. At that point in time, the POS device and the PTD disconnect and the transaction is completed.

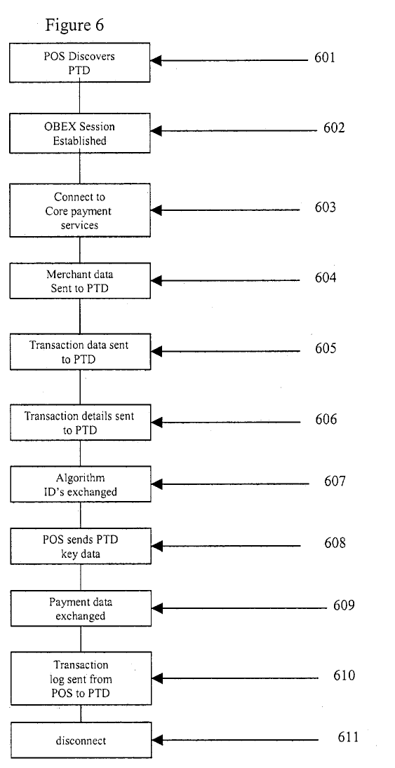

In an additional alternate embodiment, as shown in FIG. 6, a transaction may be accomplished between the POS and PTD with reporting data, such as an electronic receipt, being provided to the PTD. Again, the consumer would approach the point of sale and power on her PTD. The PTD is discovered 601 by the POS and a reliable OBEX session is established 602 between the two devices, and a connection made between the core payment services 603. The POS then provides the PTD with information related to the merchant involved in the transaction 604, which may include the name and location of the merchant, a unique identifier for the merchant, the type of business being done by the merchant and potentially additional information which is necessary or desirable to exchange. In addition, the POS sends to the PTD transaction information 605 which could then be displayed to the user. This information may include the type of transaction being executed, the amount of the transaction, including any adjustments, the currency of the transaction. Further, the POS forwards the PTD additional information related to the transaction 606, including the total number of items purchased and a listing of those items. The two devices will then exchange information on the type of security to be used 607 for the transaction and the POS will send to the PTD information defining the encryption key to be used 608. Payment information is then communicated 609 from the PTD to the POS utilizing a payment primitive, such as that shown in FIG. 4. Finally, once the transaction has been completed, the POS sends a transaction log to the PTD 610 which comprises information related to the transaction which the consumer can use to compare to his credit card bill at the end of the month. The transaction is then completed and the devices disconnect 611 from each other.

In this embodiment, the PTD can be utilized to manage and store information related to each transaction more conveniently than through paper receipts traditionally issued in a card-based transaction. The receipts may be a legally recognizable receipt which can be stored on the hand held device and may be printed therefrom. Alternately, information comprising a summary of the transaction could be stored to the PTD, which information would be useful for record keeping purposes, but otherwise would not be effective for legal purposes.

While the instant invention has been described in conjunction with the exemplary embodiments outlined above, it is evident that many alternatives, modifications and variations will be apparent to one ordinarily skilled in the art. Accordingly, the exemplary embodiments of this invention set forth above are intended to be illustrative, not limiting. Whereas, modifications or change may be made without departing from the spirit and scope of the invention or made to one skilled in the arts subsequent to review the present application. Such modifications or changes are intended to be included within the scope of the present invention.

We claim:

1. A method of conducting a transaction comprising:
placing a mobile first electronic device in infrared data communication with a second electronic device wherein both the first electronic device and the second electronic device have a common encryption algorithm;
communicating a transaction request from said second electronic device to said first electronic device wherein said transaction request includes an encryption key for use with said encryption algorithm;
communicating response data from said first electronic device to said second electronic device wherein said response data is encrypted with the encryption key; and
obtaining payment for the transaction from an account identified from said response data.

2. The method of claim 1 wherein said encryption key is a session key.

3. The method of claim 1 wherein said encryption key is a public key.

4. The method of claim 1 wherein said transaction request includes a digital certificate.

5. The method of claim 4 wherein said digital certificate comprises a public key.

6. The method of claim 1 wherein said encryption algorithm is an asymmetric encryption algorithm.

7. The method of claim 1 wherein said encryption algorithm is a symmetric encryption algorithm.

8. The method of claim 1 wherein said response data comprises a unique account number from which payment is obtained.

9. The method of claim 8 wherein said response data further comprises:
a cryptogram.

10. The method of claim 8 wherein said response data further comprises:
a digital signature; and
a public key certificate.

11. The method of claim 8 wherein said unique account number is encrypted.

12. The method of claim 11 wherein said response data further comprises:
a cryptogram.

13. The method of claim 11 wherein said response data further comprises:
a digital signature; and
a public key certificate.

14. The method of claim 8 wherein said account number is useful for effecting a credit transaction.

15. The method of claim 8 wherein said account number is useful for effecting a debit transaction.

16. The method of claim 8 wherein said account number is useful for effecting an exchange from one or more financial accounts.

17. The method of claim 8 wherein said account number is useful for effecting an exchange from one or more stored value accounts.

18. The method of claim 17 wherein one or more of said stored value accounts is an electronic cash account.

19. The method of claim 1 wherein said response data comprises domestic processing data.

20. The method of claim 19 wherein the domestic processing data comprises an identifier for the provider of the account identified from said response data.

21. The method of claim 19 wherein said domestic processing data comprises market research data.

22. The method of claim 1 wherein said response data comprises issuer program data.

23. The method of claim 22 wherein said issuer program data comprises data for customer loyalty programs.

24. The method of claim 22 wherein said issuer program data comprises an account number for a co-branded service.

25. The method of claim 22 wherein said issuer program data comprises a key to access a coupon.

26. The method of claim 22 wherein said issuer program data comprises market research data.

27. The method of claim 1 wherein said transaction is a fixed price transaction.

28. The method of claim 1 wherein said infrared communication occurs without establishing a reliable session layer connection between the first electronic device and the second electronic device.

29. The method of claim 1 further comprising:
authenticating the user of the first electronic device prior to the step of obtaining payment for the transaction.

30. The method of claim 29 wherein the authentication occurs offline.

31. The method of claim 29 wherein the authentication method is selected from a group consisting of entry of a personal identification number, biometrics, and entry of a password.

32. The method of claim 29 wherein the authentication occurs online.

33. The method of claim 29 wherein the authentication step is repeated after a pre-selected time interval.

34. A method of conducting a transaction comprising:
placing a mobile first electronic device in infrared data communication with a second electronic device wherein the first electronic device and the second electronic device has at least one common transaction service deployed thereon;
communicating from the first electronic device to the second electronic device identification of an encryption algorithm supported by the first and second electronic devices;
communicating key data from the first electronic device to the second electronic device wherein said key data can be used to encrypt and decrypt data;
communicating payment information from the first electronic device to the second electronic device; and
obtaining payment for a transaction from an account identified from said payment information.

35. The method of claim 34 further comprising:
communicating transaction information from the second electronic device to the first electronic device.

36. The method of claim 35 wherein the transaction information comprises:
the value of the transaction; and
the currency in which the transaction is conducted.

37. The method of claim 35 wherein the transaction information comprises:
a unique identifier for one or more of the parties to the transaction.

38. The method of claim 35 wherein the transaction information comprises:
the name of one or more of the parties to the transaction.

39. The method of claim 35 wherein the transaction information comprises:
the number of items being purchased.

40. The method of claim 35 wherein the transaction information comprises the date of the transaction.

41. The method of claim 35 wherein the transaction information comprises the time of the transaction.

42. The method of claim 34 wherein the encryption algorithm is an asymmetric encryption algorithm.

43. The method of claim 34 wherein the encryption algorithm is a symmetric encryption algorithm.

44. The method of claim 34 wherein the payment information comprises:
a unique account number from which payment may be obtained.

45. The method of claim 44 wherein the payment information further comprises:
a cryptogram.

46. The method of claim 44 wherein the payment information further comprises:
a digital signature; and
a public key certificate.

47. The method of claim 44 wherein said unique account number is encrypted.

48. The method of claim 47 wherein the payment information further comprises:
a cryptogram.

49. The method of claim 47 wherein the payment information further comprises:
a digital signature; and
a public key certificate.

50. The method of claim 44 wherein said account number is useful for effecting a credit transaction.

51. The method of claim 44 wherein said account number is useful for effecting a debit transaction.

52. The method of claim 44 wherein said account number is useful for effecting an exchange from one or more financial accounts.

53. The method of claim 44 wherein said account number is useful for effecting an exchange from one or more stored value accounts.

54. The method of claim 53 wherein one or more of said stored value accounts is an electric cash account.

55. The method of claim 34 wherein said payment information comprises domestic processing data.

56. The method of claim 55 wherein the domestic processing data comprises on identifier for the provider of the account identified from said payment information.

57. The method of claim 55 wherein the domestic processing data comprises market research data.

58. The method of claim 34 wherein the payment information comprises issuer program data.

59. The method of claim 58 wherein the issuer program data comprises data for customer loyalty programs.

60. The method of claim 58 wherein the issuer program data comprises an account number for a co-branded service.

61. The method of claim 58 wherein said issuer program data comprises a key to access a coupon.

62. The method of claim 58 wherein said issuer program data comprises market research data.

63. The method of claim 34 further comprising:
communicating a transaction summary from said second electronic device to said first electronic device; and
storing said transaction summary in memory located on said first electronic device.

64. The method of claim 63 wherein the transaction summary comprises the account number from which payment was obtained.

65. The method of claim 63 wherein the transaction summary comprises an authorization code for the transaction.

66. The method of claim 63 further comprising:
compiling one or more of said transaction summaries to generate a summary of all transactions effected by said first electronic device over a selected time period.

67. The method of claim 34 further comprising:
authenticating the user of the first electronic device prior to the step of obtaining payment for the transaction.

68. The method of claim 67 wherein the authentication occurs offline.

69. The method of claim 67 wherein the authentication occurs online.

70. The method of claim 67 wherein the authentication step is repeated after a pre-selected time interval.

71. The method of claim 67 wherein the authentication is selected from a group consisting of entry of a personal identification number, biometrics, and entry of a password.

72. A device for use in effecting a transaction comprising electronically accessible media wherein said media comprises a first memory location, a second memory location and a third memory location such that:
said first memory location comprises account identification data;
said second memory location comprises domestic processing data; and
said third memory location comprises issuer program data.

73. The device of claim 72 wherein said account identification data comprises a unique account number from which payment for a transaction may be obtained.

74. The device of claim 72 wherein said account identification data comprises an identifier for the user of the device.

75. The device of claim 72 wherein said domestic processing data comprises an identifier for the issuer of a transaction service deployed on the device.

76. The device of claim 72 wherein said domestic processing data comprises market research data.

77. The device of claim 72 wherein said issuer program data comprises key data for accessing coupons.

78. The device of claim 72 wherein said issuer program data comprises data for customer loyalty programs.

79. The device of client 72 wherein said issuer program data comprises an identifier for the provider of a co-brand to a transaction service deployed on the device.

80. The device of claim 72 wherein said issuer program data comprises market research data.

81. The device of claim 72 wherein said media comprises random access memory.

82. The device of claim 72 wherein said media comprises electrically erasable and programmable read only memory.
